(19) United States
(12) Patent Application Publication
(10) Pub. No.: US 2025/0315479 A1
(43) Pub. Date: Oct. 9, 2025

(54) GRAPH MODIFICATION USING DECLARATIVE COMMANDS

(71) Applicant: ServiceNow, Inc., Santa Clara, CA (US)

(72) Inventors: Min Wu, Pleasanton, CA (US); Zhe Wang, San Francisco, CA (US); Yaron Guez, San Diego, CA (US); Jan Ove Kristian Olsson, Castro Valley, CA (US)

(21) Appl. No.: 18/629,402

(22) Filed: Apr. 8, 2024

(51) Int. Cl. G06F 16/901; G06T 11/20

(52) U.S. Cl. CPC G06F 16/9024; G06T 11/206

(57) ABSTRACT

Various implementations disclosed herein include receiving an input indicating an edit to a graph, the graph including a plurality of nodes connected by a plurality of edges, and the edit targeting a portion of the graph. Upon receiving the input indicating the edit to the graph, a list of commands is generated and sent to a diagramming tool to edit that portion of the graph.

### TECHNICAL FIELD

The present disclosure relates to using data structures to modify a directed graph using declarative commands.

### BACKGROUND

In modern computing systems and environments organizing there can be a large number workflows, including devices and/or processes. In order to maintain these computing systems, it is important to track and organize these workflows and dependencies. One way to organize workflow is through a visual representation, such as a graph or diagram. However, any modifications to such a visual representation may require a significant amount of resources to ensure the workflow is updated and accurate.

### SUMMARY

One aspect of the disclosure includes a method for obtaining a graph indicating a plurality of nodes and indicating relationships between the plurality of nodes, wherein each of the plurality of nodes is associated with a corresponding one of a plurality of process elements. The method may further include receiving an edit for a portion of the graph. The method may further include, in response to receiving the edit, identifying a subset of the plurality of nodes that is associated with the portion of the graph. The method may further include, in response to receiving the edit, generating, based on the edit, a command list that targets the subset of the plurality of nodes. The method may further include, in response to receiving the edit, updating the graph by executing the command list.

Implementations of the disclosure may include one or more of the following optional features. The method may include executing the command list to update the subset of the plurality of nodes. The method may additionally include executing the command list to add an edge from one of the plurality of process elements to a new process element. The method may further include executing the command list to add an edge from the new process element to another new process element, and remove the edge from one of the plurality of process elements to the new process element. The method may further include receiving the edit for the portion of the graph is based on a user interface. The method may further include a first process element associated with a first node of the subset of the plurality of nodes and a second process element associated with a second node of the subset of the plurality of nodes. The method may further include the command list, wherein a command list is limited to targeting the subset of the plurality of nodes. The method may further include a command list, wherein the command list is stored at a buffer queue on a first-in first-out (FIFO) basis.

Another aspect of the disclosure includes a system that comprises one or more processors and a memory including computer-executable instructions. The one or more processors, when executing the computer-executable instructions, may cause the system to obtain a graph indicating a plurality of nodes and indicating relationships between the plurality of nodes, wherein each of the plurality of nodes is associated with a corresponding one of a plurality of process elements. The one or more processors may further cause the system to receive an edit for a portion of the graph. The one or more processors may further cause the system, in response to receiving the edit, to identify a subset of the plurality of nodes that is associated with the portion of the graph. The one or more processors may further cause the system, in response to receiving the edit, to generate, based on the edit, a command list that targets the subset of the plurality of nodes. The one or more processors may further cause the system, in response to receiving the edit, to update the graph by executing the command list.

This aspect of the disclosure that includes a system may include one or more of the following optional features. The one or more processors may further cause the system to execute the command list to update a relationship between two or more of the subset of the plurality of nodes. The one or more processors may further cause the system to execute the command list to add an edge from one of the plurality of process elements to a new process element; add an edge from the new process element to another new process element; and remove the edge from one of the plurality of process elements to the new process element. The one or more processors may further cause the system to generate an animation to visualize completion of the edit. The system may further comprise a plurality of nodes, wherein two or more of the plurality of nodes are associated with different process elements. The system may further comprise a subset of a plurality of nodes, wherein the plurality of nodes is limited to nodes required to complete the edit. The system may further comprise a command list, wherein the command list is stored at a buffer queue on a first-in first-out basis to delay updating the graph until execution of one or more other command lists based on one or more other edits have been completed.

Another aspect of the disclosure includes a non-transitory computer-readable storage medium having stored thereon executable instructions, which, when executed by one or more processors of a computer system, cause the computer system to obtain a graph indicating a plurality of nodes and indicating relationships between the plurality of nodes, wherein each of the plurality of nodes is associated with a corresponding one of a plurality of process elements. The computer-readable storage medium may further include instructions that cause the computer system to receive an edit for a portion of the graph. The computer-readable storage medium may further include instructions that cause the computer system, in response to receiving the edit, to identify a subset of the plurality of nodes that is associated with the portion of the graph. The computer-readable storage medium may further include instructions that cause the computer system, in response to receiving the edit, to generate, based on the edit, a command list that targets the subset of the plurality of nodes. The computer-readable storage medium may further include instructions that cause the computer system, in response to receiving the edit, to update the graph by executing the command list.

This aspect of the disclosure that includes a non-transitory computer-readable storage medium may include one or more of the following optional features. The computer-readable storage medium may further include instructions that cause the computer system to execute the command list to update a relationship between two or more of the subset of the plurality of nodes by adding or removing one or more edges. The computer-readable storage medium may further include instructions that cause the computer system to execute the command list to modify one or more edges and one or more nodes. The computer-readable storage medium may further include instructions that cause the computer system to generate a command list that is limited to targeting the subset of the plurality of nodes and one or more edges associated with the subset of the plurality of nodes. The computer-readable storage medium may further include instructions that cause the computer system to store the command list at a buffer queue as a unit on a first-in first-out basis to delay updating the graph until execution of one or more other command lists have been completed.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

Various embodiments in accordance with the present disclosure will be described with reference to the drawings, in which:

FIG. 1 illustrates a diagram editing system used to implement edits to a visual representation of a process based, at least in part, on a command list that limits edits to a portion of the visual representation, according to at least one embodiment;

FIG. 2 illustrates a sequence diagram representing a transfer of data between components of a diagram editing system based, at least in part, on a command list that limits edits to a portion of the visual representation, according to at least one embodiment;

FIG. 3 illustrates a sequence diagram representing a transfer of data between components of a diagram editing system based, at least in part, on a command list that limits edits to a portion of the visual representation, according to at least one embodiment;

FIG. 4 illustrates a flow diagram of a process used to implement edits to a visual representation of a process based, at least in part, on a command list that limits edits to a portion of the visual representation, according to at least one embodiment;

FIG. 5 illustrates a flow diagram of a process used to implement edits to a visual representation of a process based, at least in part, on a command list that limits edits to a portion of the visual representation, according to at least one embodiment; and

FIG. 6 illustrates a system in which various embodiments can be implemented, according to at least on embodiment.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

In network management, process elements may be visually represented as a set of interconnected nodes. For example, process elements may be displayed as a set of nodes with dependencies illustrated as edges. The edges may indicate connections between the nodes, where each edge starts at a first node and ends at a second node. One example visual representation known as a directed graph (digraph), includes directed edges, which indicate a flow from one node (outgoing) to another (ingoing). This type of visual representation is useful in several different contexts because the visual representation provides a simple view of complex relationships.

Editing this type of visual representation, however, is computationally expensive and inefficient. For example, editing a visual representation typically includes transmitting the entire visual representation from a client device to an editing application, regardless of the number of edits. The editing application for editing the visual representations may reside external to the client device executing the process design software (e.g., in a cloud network) used to generate visual representations (e.g., diagrams, graphs) of complex relationships in a network. Further, upon receiving the edited visual representation for the editing application, the client device re-renders the entire edited visual representation.

Thus, when an edit is received at the client device, the requested edits are transmitted along with the entire visual representation from the client device to the editing application. In turn, the editing application applies the edits to the visual representation and transmits the edited visual representations back to the client device. The client device then renders the edited visual representation at the client device. This process consumes bandwidth due to the amount of data being transferred back and forth between the client and the editing application. Further, this process consumes excessive processing power due to having to re-render the entire visual representation after each edit.

Editing visual representations would benefit from systems and methods to reduce the amount of data transmitted in editing such visual representations as well as to reduce the amount of processing power required by client devices by only rendering edited components of the visual representations. Editing visual representations would also benefit from systems and methods to provide visual feedback about edits made to those visual representations by generating animations.

In order to achieve such goals, a system of transmitting edits to a visual representation is introduced. In some implementations, the system receives an edit to a visual representation. The system then converts the edit into a command list, which includes the minimal data set that is needed by the editing application to implement the edits to the visual representation. In an embodiment, the command list limits an edit to a subset of a plurality of nodes and/or one or more corresponding edges. The system sends the command list to the editing application.

Unlike known techniques, these implementations do not require sending the entire visual representation along with the edits (e.g., command list). The system may receive a number of edits, which can be stored (as command lists) at a buffer queue on a first-in first-out (FIFO) basis. The editing application may then execute the command list to edit the visual representation. Here, only the components of the visual representation effected by the edit are changed by the editing application. The editing application may then transmit the edited portion of the visual representation back to the client device, where the client device renders the edited portion of the visual representation.

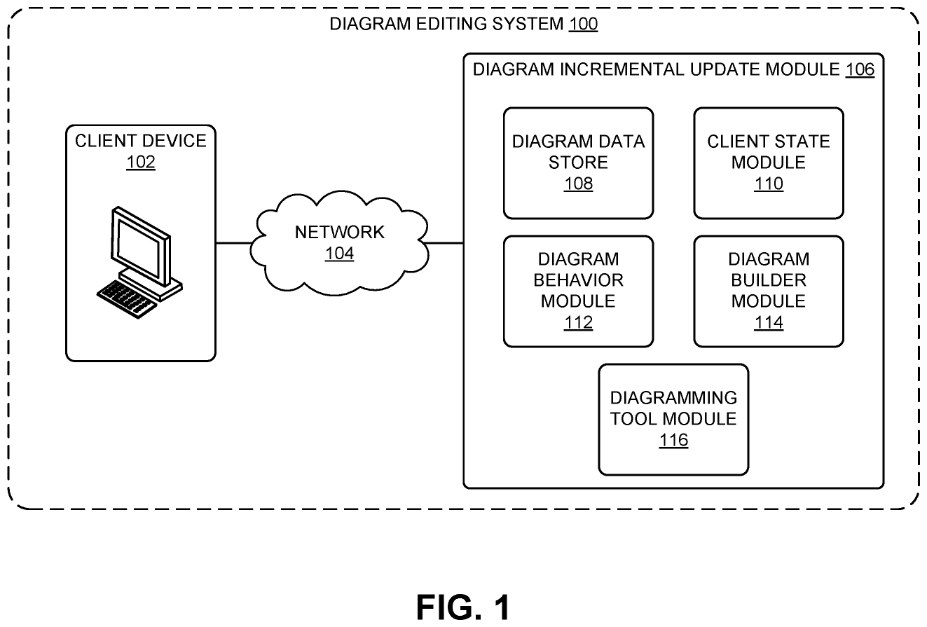

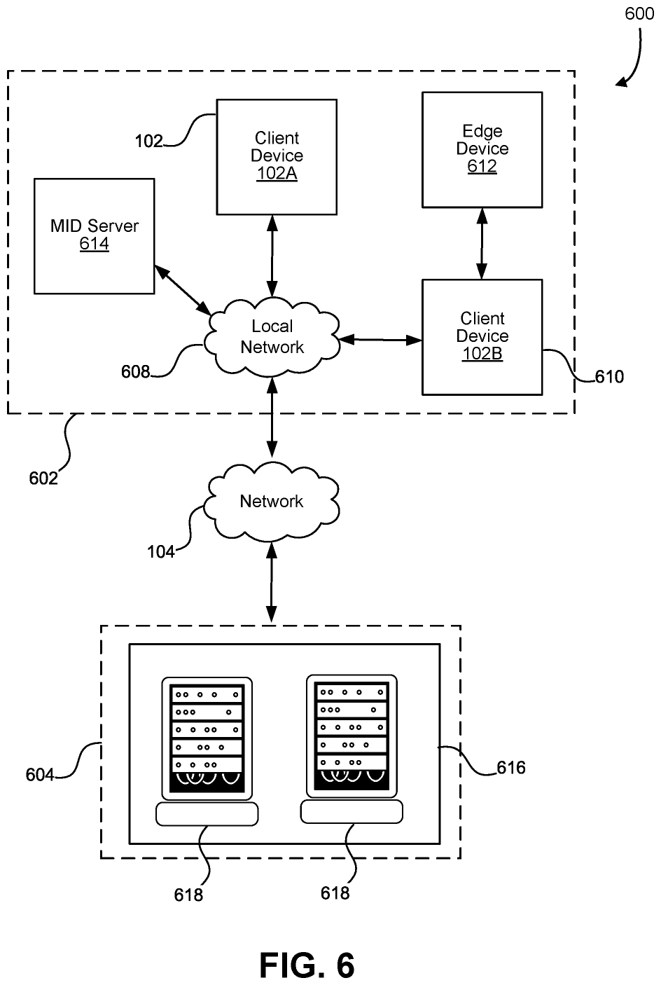

FIG. 1 illustrates a simplified block diagram of an example diagram editing system 100 that includes components that could be used to perform operations in accordance with embodiments described herein. In an embodiment, diagram editing system 100 includes at least a portion of computing system 600 of FIG. 6. Diagram editing system 100 includes a client device 102 actively operated by a user. In an embodiment, diagram editing system 100 is an editing application used to edit diagrams and is distributed across one or more components such as client device 102, network 104, and diagram incremental update module 106. In an embodiment, client device 102 could be one or more of any type of computing device such as a server (e.g., a device that provides computational services), desktop computer, laptop computer, smartphone, or some combination thereof. In at least one embodiment, client device 102 includes at least a portion of client device 102A, client device 102B, or some combination thereof, of FIG. 6. In an embodiment, client device 102 is client device 102A or client device 102B of FIG. 6.

Client device 102 may include process design software used to generate visual representations (e.g., diagrams, graphs) of a process. In an embodiment, process design software is user-accessible software that requires little-to-no coding to receive indications of desired edits to a visual representation, while an editing application is not accessible to a user and performs modifications to the data that creates the visual representation. Client device 102 may access process design software located in the cloud. Process design software may receive a request from a user or application to implement an edit for a portion of a visual representation of a process via a user interface run by that process design software. Client device 102 may include a user interface that receives user interaction (e.g., user input). Client device 102 may run process design software that generates and/or displays a list of potential edits to a graph to a user. The user may then select a potential edit, such as adding a node, where client device 102 receives the selected potential edit as input. In an embodiment, selecting a potential edit also allows a user to input via a user interface and/or command line, indications related to process elements to be added, removed, or modified. For example, a user may input indications of where a node should be added, what type of node should be added, and what dependencies that node might have with existing nodes. Client device 102 may include a display device to display a visual representation of a process. In an embodiment, client device 102 includes and/or accesses at least a portion of an editing application via process design software.

In an embodiment, client device 102 is communicatively connected to network 104. Network 104 may be one or more of any type of network, such as a managed network (e.g., enterprise network), cloud network, internet, local private network, or some combination thereof. In an embodiment, network 104 of FIG. 1 is network 104 of FIG. 6. In an embodiment, network 104 is local network 608 of FIG. 6. Network 104 of FIG. 1 may be one or more portions or any combination of portions of network 104 and local network 608 of FIG. 6. Network 104 is communicatively connected to at least a component of diagram incremental update module 106.

In an embodiment, diagram incremental update module 106 includes an editing application used to edit a visual representation (e.g., a diagram) of a process. Diagram incremental update module 106 includes diagram data 108, client state module 110, diagram behavior module 112, diagram builder module 114, diagramming tool module 116, or some combination thereof.

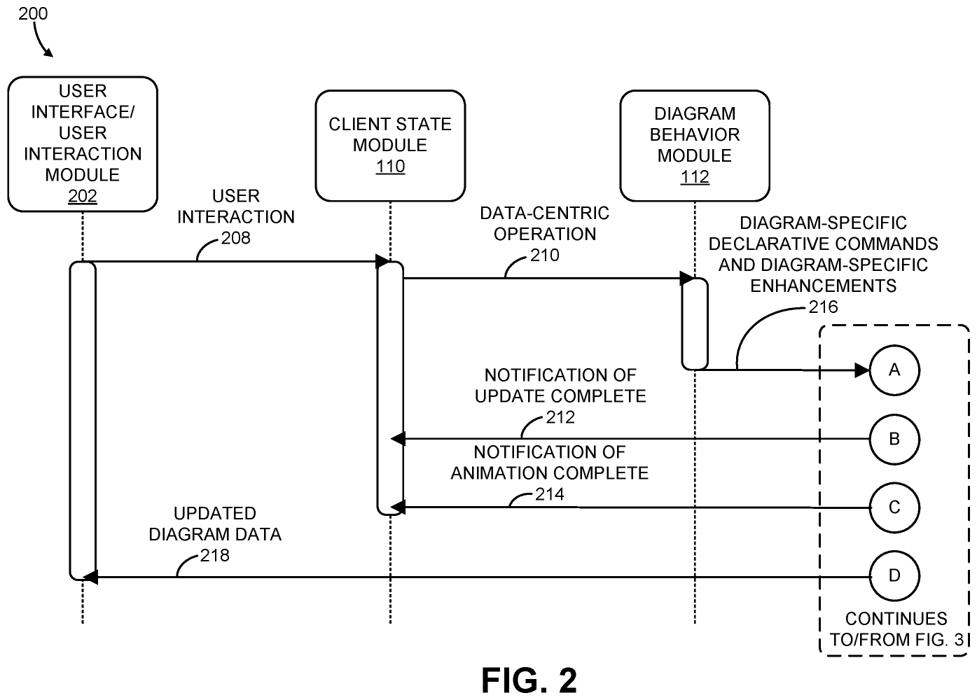

In an embodiment, diagram editing system 100 uses systems and methods to improve the editing process for diagrams by reducing the amount of processing power required by client device 102. Diagram editing system 100 receives an edit to a diagram via client device 102. Diagram editing system 100 then transfers the edit via network 104 to diagram incremental update module 106. Diagram incremental update module 106 includes a module, such as diagram behavior module 112, to convert the edit into a list of commands, also referred to as a command list, which includes the minimum data required by an editing application to implement the edits to the diagram. In an embodiment, an edit comprises information about one or more dependencies of a plurality of nodes. Two or more of a plurality of nodes may be associated with different process elements. In an embodiment, an input representing a selected edit is translated into a command list useable by software such as diagramming tool module 116 to modify the graph. A command list includes one or more instructions. In an embodiment, the minimum data required is identified by client state module 110. In an embodiment, diagram editing system 100 includes an editing application installed on one or more modules, such as diagram behavior module 112, diagram builder module 114, diagramming tool module 116, or some combination thereof. An editing application of diagram incremental update module 106 then executes the command list to edit the diagram by only changing the components of the diagram necessary to implement the edit. The editing application of diagram incremental update module 106 will then transmit the edited portion of the diagram back to client device 102 via network 104, where client device 102 renders the edited portion of the diagram. Techniques used by diagram editing system 100 as described in conjunction with FIG. 1 are also described herein at least in conjunction with FIGS. 2-6.

In at least one embodiment, terms such as “component,” “device,” “tool,” and “module” each refer to software logic, firmware logic, hardware logic, circuitry, or some combination thereof, configured to perform operations described herein. Any component, device, tool, and module described herein can be combined and/or communicatively connected with at least one other component, device, tool, and module, regardless of how such components are described to be combined and/or communicatively connected in specific embodiments.

In an embodiment, diagram data store 108 is a storage device (e.g., on-processor memory) that stores data representing a diagram, a type of visual representation. The diagram may be a digraph. In an embodiment, digraphs are data structures that store data in vertices or nodes which may be connected to one another by directional edges, shown as arrows. These data structures may be used for a variety of applications. For example, digraphs may depict social networks, where each node may be a person, and the edges may show relationships between people. As another example, digraphs may be used by businesses and corporations for project management, where the nodes represent tasks, activities, or entities, and the directed edges indicate dependencies between the nodes. Digraphs may be referred to as a diagram, workflow diagram, or flow diagram.

In at least one embodiment, a diagram, including all data pertaining to the nodes and directed edges, hereafter referred to as process data, may be stored at a storage location such as a database. A user may manipulate elements of a diagram by interacting with a user interface of client device 102 that displays that diagram or a representation thereof. For example, the user may modify a diagram via a user interface to add or delete nodes and directed edges of a diagram, or alter how the nodes are connected by the directed edges to reflect desired changes to activity paths, e.g., a flow of activity indicated by the directed edges. These changes may be saved to a database storing the process data of the diagram. The activity paths may also be referred to as process flows.

In at least one embodiment, for project management, diagrams may be used to efficiently represent desired or target process flows for completion of a project. For example, an order that the nodes are to be performed may be indicated by the directed edges. A node may have incoming edges, which may be directed edges pointing from nodes precedent to (e.g., to be performed before) the node, as well as outgoing edges, which may be directed edges pointing from the node to a subsequent (e.g., to be performed after) node. A user may modify or edit a diagram by adding or deleting a task, which in turn adds and deletes both corresponding directed edges and nodes of the diagram, as well as adjusts how the directed edges connect the nodes. Modification of the diagram may, however, require significant computing resources and/or time because the entire diagram, with indications of modifications to be made, may be submitted to a diagram modification tool.

The present disclosure relates to a method, which may be performed by one or more processors, which may include obtaining a graph comprising a plurality of nodes and a plurality of edges. Each node of the plurality of nodes may be interconnected to at least one other node from the plurality of nodes via a respective edges of the plurality of edges. Each edge of the plurality of edges may include a respective starting point at a respective start node and a respective end point at a respective end node. The method may also include receiving, via a user interface, an input indicating an edit to the graph and, in response to receiving the edit, modifying the graph based on the edit.

In an embodiment, client state module 110 stores and updates client state information, also referred to as client state parameters. Client state information is data that indicates one or more characteristics or properties of tasks, activities, entities, or some combination thereof, included in a process. Client state information may include indications of dependencies between those two or more of those tasks, activities, or entities. Client state module 110 of FIG. 1 is client state module 110 of FIG. 2. Client state module 110 identifies the minimal data set required by an editing application to implement the edits to the diagram. In an embodiment, the minimum data required by an editing application includes a subset of a plurality of nodes of a diagram that are relevant to implementing an edit to the diagram.

In an embodiment, diagram behavior module 112 receives or otherwise obtains the minimum data required by an editing application to implement edits to a diagram. Diagram behavior module 112 is diagram behavior module 112 of FIG. 2. In an embodiment, diagram behavior module 112 generates a command list based on the minimal data set. In an embodiment, a command list is list of declarative commands such as adding, deleting, or updating one or more nodes. A list of declarative commands may also include adding, deleting, or updating one or more edges.

In an embodiment, declarative commands are generated based, at least in part, on techniques used to determine that modifying a diagram causes a particular node of the diagram to be isolated, and, in response to determining that modifying the diagram based on the modification causes the particular node of the diagram to be isolated, generating a hidden edge comprising an invisible graphical user element to connect to the particular node of the diagram to at least one other node of the plurality of nodes of the diagram.

In at least an embodiment, declarative commands are generated based, at least in part, on techniques used to maintain a layout of a digraph during user edits as described in co-pending U.S. patent application Ser. No. 18/619,889, titled “GRAPH LAYOUT RETENTION USING HIDDEN EDGES,” [Placeholder: Attorney Docket No. 010864-007US0] which is incorporated by reference in its entirety herein. In at least one embodiment, such techniques implement invisible graphical user elements to maintain the diagram layout as various components of the diagram are edited and/or deleted. Hidden edges may include a data structure that is maintained in a display or rendering of the diagram, though not visible to an end user. For example, if a user deletes every incoming edge connected to a particular node in the diagram, the incoming edges may be deleted from the display and the changes may be persisted to storage (e.g., a database storing process data of the diagram). From the user's perspective, the incoming edges are successfully deleted and process execution logic (e.g., process data) corresponding to the diagram may be updated accordingly. At least one hidden edge may be inserted into the diagram, however, to replace one or more of the deleted incoming edges in order to preserve the position of the particular node.

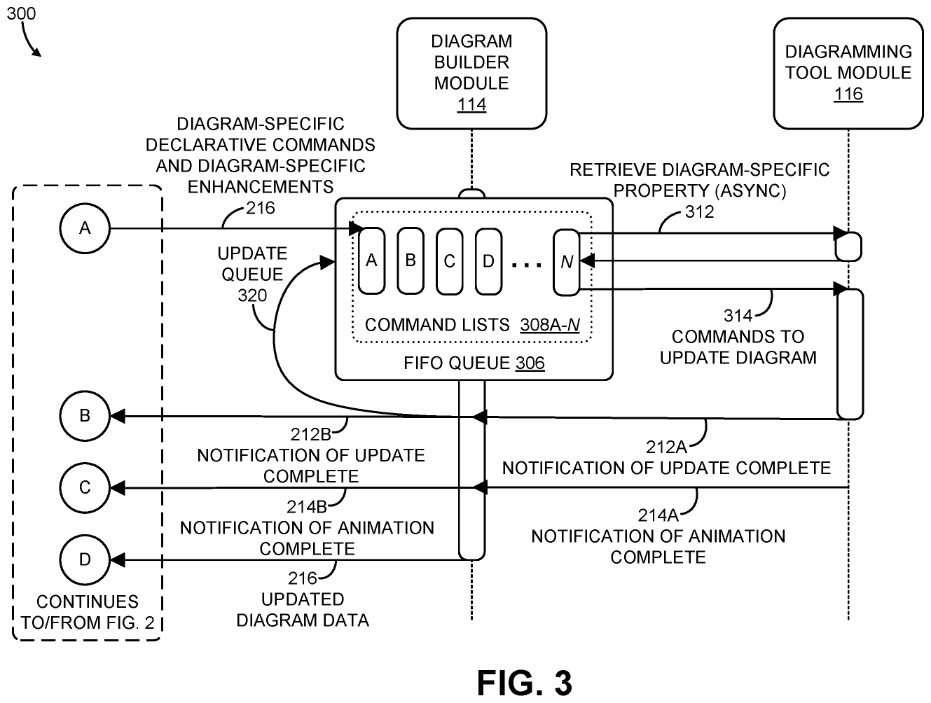

In an embodiment, diagram builder module 114 receives or otherwise obtains a command list from diagram behavior module 112. In an embodiment, diagram builder module 114 of FIG. 1 is diagram builder module 114 of FIG. 3. Diagram builder module 114 stores one or more instructions of a command list at a buffer queue on a first-in first-out (FIFO) basis. In an embodiment, the buffer queue is FIFO queue 306 of FIG. 3. The buffer queue may be implemented as a part of diagram builder module 114. The buffer queue allows a command list corresponding to a specific edit to a diagram to be completed before beginning another command list corresponding to a different edit to the diagram. For example, one or more instructions of a command list are stored in a queue on a first-in first-out (FIFO) basis to delay modifying a graph until execution of one or more other instructions used to modify the graph has been completed Queuing the command lists allows updates to the diagram to be incrementally implemented and allows a user to see updates as they occur or are completed.

In an embodiment, diagramming tool module 116 receives or otherwise obtains a command list from diagram builder module 114. Diagramming tool module 116 may be referred to as an underlying diagramming tool, in part, because diagramming tool module 116 may not be visible and/or accessible to one or more components of system 100. In an embodiment, diagramming tool module 116 of FIG. 1 is diagramming tool module 116 of FIG. 3. Diagramming tool module 116 executes each declarative command of the command list to implement an edit to a portion of a diagram. In an embodiment, diagramming tool module 116 modifies the diagram (e.g., graph) using one or more instructions that represent the declarative commands of the command list. In an embodiment, diagramming tool module 116 uses one or more instructions of a command list to modify the graph to update a relationship (e.g., a dependency) between two or more nodes. Modifying a graph to update a relationship between two nodes may include adding or removing one or more edges. In an embodiment, diagramming tool module 116 transmits the edited portion of the diagram back to client device 102 via network 104.

FIG. 2 illustrates a sequence diagram 200 representing the transfer of data between components of a diagram editing system along a vertical timeline, according to an embodiment. Sequence diagram 200 includes user interface/user interaction module 202. In an embodiment, user interface/user interaction module 202 is part of client device 102 of FIG. 1. Sequence diagram 200 includes client state module 110. In an embodiment, client state module 110 of FIG. 2 is client state module 110 of FIG. 1. Sequence diagram 200 includes diagram behavior module 112. In an embodiment, diagram behavior module 112 of FIG. 2 is diagram behavior module 112 of FIG. 1.

In an embodiment, user interface/user interaction module 202 receives or otherwise obtains a user interaction. A user may be referred to as a process author, where the process is represented as a diagram. A user interaction may include an input from a user indicating or requesting a specific edit to a diagram. An edit may include adding, removing, updating, or some combination thereof, a node of a diagram. User interface/user interaction module 202 receives or otherwise obtains each user-requested edit one at a time. In response to receiving a user interaction, user interface/user interaction module 202 transmits the user interaction, or an indication thereof, as user interaction 208 to client module 110.

In an embodiment, in response to receiving or otherwise obtaining user interaction 208, client state module 110 identifies characteristics or properties of a portion of a diagram that are relevant to implementing an edit to that portion of that diagram. In an embodiment, client state module 110 identifies a specific edit in user interaction 208. Characteristics or properties of a portion of a diagram may include specific nodes, edges, data values, or some combination thereof, that will be affected by the edit. In an embodiment, client state module 110 transmits a data-centric operation 210 to diagram behavior module 112. A data-centric operation may include an indication of a specific type of edit to specific nodes and/or edges of a diagram.

In an embodiment, in response to receiving or otherwise obtaining data-centric operation 210, diagram behavior module 112 generates a list of declarative commands, which may be referred to as a command list. Diagram behavior module 112 may translate data-centric operation 210 into declarative commands useable by diagramming tool module 116 of FIG. 3 since data-centric operation 210 may be written in an programming language or may use an application programming interface (API) library different from one used by the underlying diagramming tool. In an embodiment, an programming language or API library used by an underlying diagramming tool is specific to editing graphs, such as diagrams. In an embodiment, a programming language used by software of a diagramming tool is different from an programming language used by a client device that receives an input indicating an edit. Declarative commands may include commands to add, remove, update, or some combination thereof, specific nodes and/or edges of a portion of a diagram to effect the user-requested edits to the diagram. Declarative commands may be referred to as diagram-specific declarative commands. In an embodiment, diagram behavior module 112 generates diagram-specific enhancements such as animations to be displayed on a client device that indicates an implementation of an edit. In an embodiment, diagram behavior module 112 transmits declarative commands and enhancements to a FIFO queue as depicted with diagram-specific declarative commands and diagram-specific enhancements 216. Diagram-specific declarative commands and diagram-specific enhancements 216 is shown in FIG. 2 as being sent to connector circle A, which continues with the connector circle A of FIG. 3.

In an embodiment, a notification of a completed edit, notification of update complete 212, is received from diagram builder module 114 of FIG. 3 and is sent to client state module 110 of FIG. 2. In an embodiment, a notification of a completed animation, notification of animation complete 214, is received from diagram builder module 114 of FIG. 3 and is sent to client state module 110. In an embodiment, an edited portion of the diagram, updated diagram data 218, is received from diagram builder module 114 of FIG. 3 and is sent to user interface/user interaction module 202. Notifications and data received from modules of FIG. 3 are indicated by connector circles B, C, and D.

FIG. 3 illustrates a sequence diagram 300 representing the transfer of data between components of a diagram editing system along a vertical timeline, according to an embodiment. Sequence diagram 300 includes diagram builder module 114. In an embodiment, diagram builder module 114 of FIG. 3 is diagram builder module 114 of FIG. 1. Sequence diagram 300 includes diagramming tool module 116. Diagramming tool module 116 may be implemented as part of diagram builder module 114. In an embodiment, diagramming tool module 116 of FIG. 3 is diagramming tool module 116 of FIG. 1.

In an embodiment, diagram-specific declarative commands and diagram-specific enhancements 216 are received from diagram behavior module 112 of FIG. 2. Diagram-specific declarative commands and diagram-specific enhancements 216 are stored in FIFO queue 306 of diagram builder module 114. Diagram-specific declarative commands and diagram-specific enhancements 216 are depicted as command lists 308A-N, where N represents a total number of command lists stored in FIFO queue 306.

In an embodiment, diagramming tool module 116 retrieves a diagram-specific property required for the edit to the diagram. Retrieving data is also referred to as receive or otherwise obtaining data. Diagramming tool module 116 retrieves diagram-specific property asynchronously, as depicted with the transmission identified by retrieve diagram-specific property (async) 312. In at least one embodiment, a diagram-specific property is stored as meta-data. In an embodiment, a declarative command of a command list triggers extra meta-data fetching based on a type of node or a type of edge included in the declarative command. A diagram-specific property may include a type of node, a type of edge, a shape of a node, or some combination thereof. For example, if a node is to be added to a diagram but its shape information has not been retrieved and/or loaded to a cache of diagramming tool module 116 yet, the shape information will be fetched on demand as depicted with retrieve diagram-specific property (async) 312. In an embodiment, the shape of a node represents a type of node, or a type of activity represented by that node. In an embodiment, if shape information of a node has not been loaded yet, an edit with that node, such as adding that node to a diagram, will not be made until the shape information is received and/or cached. In an embodiment, waiting to implement an edit until shape information is loaded is a type of lazy loading where loading of the shape information is not performed until that shape information is required by a component of an editing application, such as diagramming tool module 116 of FIG. 3.

In an embodiment, after retrieving diagram-specific property (async) 312, diagramming tool module 116 accesses FIFO queue 306 to retrieve the next command list in the queue, as depicted with the transmission identified as commands to update diagram 314. In an embodiment, FIFO queue 306 sends the next command list in the queue to diagramming tool module 116. A command list may be transmitted to diagramming tool module 116 as an atomic unit, which is a single executable workload unit, and is used to make a single update to the diagram. A single update can include one or more operations or modifications to a graph. For example, a single update may include modifications that add two nodes and an edge connecting those two nodes. In an embodiment, an underlying diagramming tool, such as diagramming tool module 116, refers to an editing application, or portion thereof, that performs or implements the actual edits to the diagram.

In an embodiment, in response to retrieving a command list, such as the transmission of commands to update diagram 314, diagramming tool module 116 performs operations to execute the command list. In an embodiment, to initially create a diagram, a command list is sent to diagramming tool module 116 instead of a diagram data set used in initial loading. The command list to initially create a diagram would cause a single update in diagramming tool module 116, which, in turn, would cause a visual effect resembling a visual effect that results from sending a complete diagram data set to the diagramming tool. As a result of sending a command list to create the initial diagram, diagramming tool module 116 would not need to handle two data types, that is, the diagram data set for initial loading and the command list for diagram changes. A command list can be referred to as an incremental update command list.

In an embodiment, in response to completing an edit to a portion of a diagram, diagramming tool module 116 sends a notification that the edit is complete to diagram builder module 114, as depicted with the transmission of notification of update complete 212A. In response to completing an animation representing an edit to a portion of a diagram, diagramming tool module 116 sends a notification that the animation is complete, to diagram builder module 114, as depicted with the transmission of notification of animation complete 214A.

In an embodiment, in response to receiving a notification that an edit is complete, diagram builder module 114 sends an instruction to FIFO queue 306 to update the command lists in that queue, as depicted with the instruction depicted as update queue 214. In an embodiment, FIFO queue 306 updates the command lists in its queue by removing the command list corresponding to the notification that an edit is complete. FIFO queue 306 may also update the command lists in its queue by adding the next command list received or otherwise obtained from diagram behavior module 112 of FIG. 2.

In an embodiment, in response to receiving a notification that an edit is complete, diagram builder module 114 forwards that notification to client state module 110 of FIG. 2, as depicted with the transmission of notification of update complete 212B. In an embodiment, notification of update complete 212B is notification of update complete 212 of FIG. 2. In an embodiment, in response to receiving a notification that an animation is complete, diagram builder module 114 forwards that notification to client state module 110 of FIG. 2, as depicted with the transmission of notification of animation complete 214B. In at least one embodiment, notification of animation complete 214B is notification of animation complete 214 of FIG. 2. In an embodiment, in response to receiving a notification that an edit is complete, diagram builder module 114 sends the edited portion of a diagram to a client device, such client device 102 of FIG. 1, and as depicted by the transmission of data identified as updated diagram data 218.

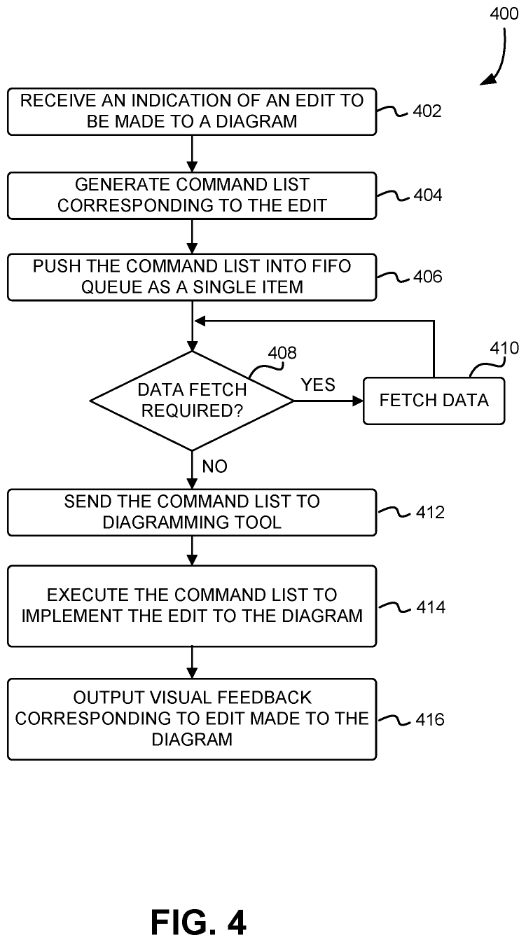

FIG. 4 illustrates an example process 400 to edit a portion of a diagram, according to at least one embodiment. The process data may be stored in a database, in accordance with at least one embodiment. In at least one embodiment, a computing system comprising diagram editing system 100 of FIG. 1, computing system 600 of FIG. 6, or some combination thereof, performs one or more operations of process 400. In at least one embodiment, at least one of the one or more computing devices may include one or more processors configured with executable instructions to perform one or more steps of process 400.

In an embodiment, diagram editing system 100 of FIG. 1 performs one or more operations process 400. In an embodiment, diagram editing system 100 performs operation 402 of process 400 to receive an indication of an edit requested by a user or an application to be made to a diagram. A diagram can be any type of visual representation of a process, including graphs. An indication of an edit may be received via a client device, such as client device 102, which are described further herein at least in conjunction with FIGS. 1 and 6. In an embodiment, an edit may be the addition, deletion, or updating of a node or edge in the diagram. An edit to a diagram may be requested to remove or reorder one or more activities and/or tasks represented as nodes. An edit to a diagram may be requested to remove or change the dependency between two or more activities and/or tasks that represented as nodes.

In an embodiment, diagram editing system 100 performs operation 404 of process 400 to generate a command list corresponding to the edit, where a command list is also referred to as a list of commands, a declarative list of commands, or an incremental update command list. In an embodiment, a command list is a set of instructions required to implement an edit in a portion of a diagram. Generating a command list may include translating the indication of the edit from one programming language into another programming language. For example, a command list may include multiple instructions required by an editing application to add a single node and corresponding edges to a diagram. In an embodiment, a command list is generated by a diagram behavior module as described further herein at least in conjunction with FIGS. 1, 2 and 5.

In an embodiment, diagram editing system 100 performs operation 406 of process 400 to push the command list into a FIFO queue as a single item. Pushing a command list into a queue may also be referred to as storing a command list at or in a queue. The FIFO queue is used, at least in part, to allow incremental edits, also known as updates, to a diagram, which provides the benefit of reducing the amount of data transferred between a diagramming tool and a client device. Incremental updates also allow updates to portions of the diagram to be visualized one at a time, allowing a user to more easily identify updates to the diagram as they occur or as they are completed. The visualizations may include animations such as changing colors, changing brightness, changing shapes, movement, or some combination thereof, of nodes and/or edges that are being added, removed, or updated. In an embodiment, an edit may be repeated or undone by reverting, reversing, or repeating each command in a corresponding command list.

In an embodiment, diagram editing system 100 performs operation 408 of process 400 by identifying whether a data fetch is required before an edit is sent to a diagramming tool. A data fetch refers to retrieving data and is described further herein at least in conjunction with retrieve diagram-specific property (async) 312 of FIG. 3. In an embodiment, a data fetch is required if meta-data corresponding to a node type or edge type included in a command of a command list has not been loaded to a cache accessible by a diagramming tool. If a data fetch is required, then diagram editing system 100 performs operation 410 to fetch the required data. If no data fetch is required, the diagram editing system performs operation 412.

Operation 412 of process 400 includes sending the command list to a diagramming tool, such as underlying diagramming tool of FIG. 3. In an embodiment, after a diagramming tool of diagram editing system 100 completes a command list of an edit, the diagramming tool notifies a FIFO queue to remove the completed command list and to send the next command list in the queue. To cause a queue to remove a completed command list can be referred to as causing the queue to pop that command list.

In an embodiment, diagram editing system 100 executes the command list to implement the edit to the diagram with operation 414. In an embodiment, the command list includes a minimal number of commands required to implement an edit to the diagram. Once each of the command list is executed, a notification of a completed edit is sent to diagram builder module 114 and client state module 110 as described further herein at least in conjunction with FIGS. 2 and 3.

In an embodiment, diagram editing system 100 outputs visual feedback corresponding to the edit made to the diagram with operation 416. The visual feedback may indicate a localized area of the diagram where the edit was made by rendering a visual cue or animation at that area. In addition, by updating edits to a diagram incrementally, the diagram editing system 100 visualize each edit as they are completed, allowing a user to observe the edits as they occur or as they are completed.

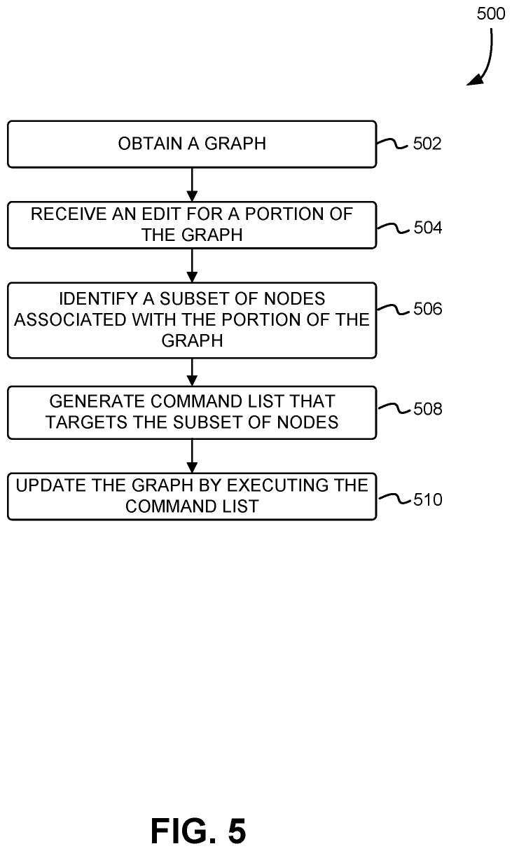

FIG. 5 illustrates an example process 500 to edit a portion of a diagram, according to at least one embodiment. The process data may be stored in a database, in accordance with at least one embodiment. In at least one embodiment, a computing system comprising diagram editing system 100 of FIG. 1, computing system 600 of FIG. 6, or some combination thereof, performs one or more operations of process 500. In at least one embodiment, at least one of the one or more computing devices may include one or more processors configured with executable instructions to perform one or more steps of process 500. In at least one embodiment, one or more operations of process 500 are included in one or more operations of process 400.

In an embodiment, diagram editing system 100 of FIG. 1 performs one or more operations to obtain a graph with operation 502. The graph may be a visual representation of a process, such as a diagram (e.g., digraph). The graph may include a plurality of nodes and plurality of edges each connecting a pair of the plurality of nodes. The graph may include indications of a plurality of nodes and indications of relationships between those nodes, wherein each of the nodes is associated with a process element such as a task, activity, or action. In an embodiment, a graph is obtained via a client device such as client device 102 of FIG. 1. As described further herein, an edit may target a subset of a plurality of nodes and one or more edges associated with that subset. In an embodiment, different process elements may be represented by different nodes. For example, a first process element may be associated with a first node of a subset of the plurality of nodes and a second process element may be associated with a second node of the subset of the plurality of nodes.

In an embodiment, diagram editing system 100 performs one or more operations to receive an edit for a portion of the graph with operation 504. An edit is a modification to the graph, such as an addition, deletion, or update to a node and/or edge as described further herein at least in conjunction with FIGS. 1-4.

In an embodiment, diagram editing system 100 performs one or more operations to identify a subset of nodes associated with the portion of the graph in response to receiving the edit of operation 504. In an embodiment, identifying a subset of nodes includes an identification of a subset of edges and any other elements the graph representing a process. Identifying a subset of process elements, such as a subset of nodes or edges, identifies those process elements that will be modified (e.g., added, deleted, updated) in order to effect an edit. A technical benefit of identifying only a subset of nodes and/or other process elements associated with an edit for a portion of the graph is that a diagram editing system identifies less than all of the nodes of a graph, which reduces processor utilization.

In an embodiment, diagram editing system 100 performs one or more operations to generate a command list that targets the subset of nodes based on the edit with operation 508. In an embodiment, the command list targets the subset of nodes required to complete an edit. Generating a command list that targets the subset of nodes based on the edit provides a technical benefit by reducing the amount of data transmitted in editing a graph as well as reducing the amount of processing power required by client device by only rendering edited components of the graph, transmitting data for an entire graph and rendering an entire graph. Generating a command list is described further herein at least in conjunction with FIGS. 1-4.

In an embodiment, diagram editing system 100 performs one or more operations of operation 510 to update the graph by executing the command list that targets the subset of a plurality of nodes. Executing the command list may update the subset of the plurality of nodes by adding or removing a node to that subset as described further herein at least in conjunction with FIGS. 1-4. In an embodiment, executing the command list includes adding new process elements, represented by new nodes, and/or removing edges. For example, a command list may include instructions to add a new node and an edge between an existing node and the new node, add two new nodes and an edge between those two new nodes, or remove an existing edge. In an embodiment, a command list may include instructions to add an edge from one of a plurality of process elements to a new process element, add an edge from the new process element to another new process element, and remove the edge from one of the plurality of process elements to the new process. A technical benefit of being able to update the graph by executing the command list that targets the subset of nodes is a reduction of an amount of data transmitted to edit the graph and a reduction in the amount of processing power required to render the graph by limiting commands to edits for a subset of nodes. Otherwise, more commands would be required to edit and/or render the graph due to having to send data for an entire graph and rending an entire graph.

In at least one embodiment, a processor performs one or more operations of process 400 and/or process 500 by using one or more systems described in FIG. 6 (e.g., see elements 102, 604, 612, 614, 616 and 618 of FIG. 6). In at least one embodiment, one or more steps in process 400 and/or process 500 are otherwise combined, performed in series, and/or performed in parallel. In at least one embodiment, some or all of process 400 and/or process 500 (or any other processes described herein, or variations and/or combinations thereof) is performed under control of one or more computer systems configured with computer executable instructions and is implemented as code (e.g., computer executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors.

In at least one embodiment, a computer-readable storage medium is a non-transitory computer-readable storage medium. In at least one embodiment, at least some computer-readable instructions usable to perform process 400 and/or process 500 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 400 and/or process 500 is performed at least in part on a computer system such as those described elsewhere in this disclosure. In at least one embodiment, logic (e.g., hardware, software, or a combination of hardware and software) performs process 400 and/or process 500.

FIG. 6 illustrates a system 600 in which various embodiments can be implemented. The computing system 600 may include a client network 602 and a provider platform 604 that are operably connected via a network 104 (e.g., the Internet). In an embodiment, the client network 602 may be a private local network 608, such as a local area network (LAN) that includes a variety of network devices that include, but are not limited to, switches, servers, and routers. In an embodiment, the client network 602 can comprise an enterprise network that can include one or more LANs, virtual networks, data centers, and/or other remote networks. In an embodiment, the client network 602 can be operably connected to one or more client devices 102 such as example client device 102A, 102B so that the client devices 102 are able to communicate with each other and/or with the provider platform 604. In at least one embodiment, a digraph may be displayed at one or more of the client devices 102, which may be generated and modified using the client devices 102. Moreover, in at least one embodiment, the client devices 102 may be configured with algorithms for generating an invisible graphical user element to be used in conjunction with algorithms for managing the digraph. The invisible graphical user element, which may include a data structure for a hidden edge, may be stored locally at the client devices 102.

In an embodiment, the client devices 102 can be computing systems and/or other types of computing devices generally referred to as Internet of Things (IoT) devices that can access cloud computing services, for example, via a web browser application or via an edge device 612 that may act as a gateway between one or more client devices 102 and the platform 604 (e.g., second client device 102B). One or more client devices 102 may be a server. In an embodiment, the client network 602 can include a management, instrumentation, and discovery (MID) server 614 that facilitates communication of data between the network hosting the platform 604, other external applications, data sources, and services, and the client network 602. In an embodiment, the client network 602 may also include a connecting network device (e.g., a gateway or router) or a combination of devices that implement a customer firewall or intrusion protection system.

In an embodiment, the client network 602 can be operably coupled to the network 104, which may include one or more suitable computing networks, such a large area network (LAN), wide area networks (WAN), the Internet, and/or other remote networks, that are operable to transfer data between the client devices 102 and the provider platform 604. In an embodiment, one or more computing networks within network 104 can comprise wired and/or wireless programmable devices that operate in the electrical and/or optical domain. For example, network 104 may include wireless networks, such as cellular networks (e.g., Global System for Mobile Communications (GSM) based cellular network), WIN networks, and/or other suitable radio-based networks. The network 104 may also employ any suitable network communication protocols, such as Transmission Control Protocol (TCP), Internet Protocol (IP), and the like. In an embodiment, network 104 may include a variety of network devices, such as servers, routers, network switches, and/or other suitable network hardware devices configured to transport data over the network 104.

In an embodiment, the provider platform 604 may be a remote network (e.g., a cloud network) that is able to communicate with the client devices 102 via the client network 602 and network 104. In an embodiment, the provider platform 604 can comprise a configuration management database (CMDB) platform. In an embodiment, the provider platform 604 provides additional computing resources to the client devices 102 and/or the client network 602. For example, by utilizing the provider platform 604, in some examples, users of the client devices 102 are able to build and execute applications for various enterprise, IT, and/or other organization-related functions. In one embodiment, the provider platform 604 can be implemented on the one or more data centers 616, where each data center 616 can correspond to a different geographic location in some examples. In an embodiment, one or more of the data centers 616 includes a plurality of servers 618 (also referred to in some examples as application nodes, virtual servers, application servers, virtual server instances, application instances, application server instances, or the like), where each server 618 can be implemented on a physical computing system, such as a single electronic computing device (e.g., a single physical hardware server) or across multiple-computing devices (e.g., multiple physical hardware servers). Examples of servers 618 can include a virtual server, a web server (e.g., a unitary Apache installation), an application server (e.g., a unitary Java Virtual Computer), and/or a database server.

In at least one embodiment, one or more databases may be included at one or more of the servers 618, where the database may store process data for the digraph. For example, the process data may be information regarding how the digraph is to be displayed, including how nodes of the digraph are connected. Modifications to the digraph may be persisted to the database, such as addition and deletion of the nodes, addition and deletion of directed edges, etc. The database may further store rules for how the digraph is to be structured and displayed. The process data stored at the database may be used in combination with the user interface construct, the user interface construct stored at one or more of the client devices 102, to manage display and modification of the digraph.

To utilize computing resources within the provider platform 604, in an embodiment, network operators may choose to configure the data centers 616 using a variety of computing infrastructures. In an embodiment, one or more of the data centers 616 can be configured using a multi-instance cloud architecture to provide every customer with its own unique customer instance or instances. For example, a multi-instance cloud architecture of some embodiments can provide each customer instance with its own dedicated application server and dedicated database server. In some examples, the multi-instance cloud architecture could deploy a single physical or virtual server 618 and/or other combinations of physical and/or virtual servers 618, such as one or more dedicated web servers, one or more dedicated application servers, and one or more database servers, for each customer instance. In an embodiment of a multi-instance cloud architecture, multiple customer instances can be installed on one or more respective hardware servers, where each customer instance is allocated certain portions of the physical server resources, such as computing memory, storage, and processing power. By doing so, in some examples each customer instance has its own unique software stack that provides the benefit of data isolation, relatively less downtime for customers to access the platform 604, and customer-driven upgrade schedules.

In some embodiments, the provider platform 604 includes a computer-generated data management server that receives, via network 104 and/or an internal network within or across different data centers, computer-generated data for storage and analysis. For example, log entries can be sent from client devices 102, MID server 614 (e.g., agent server acting as the intermediary in client network 602 to facilitate access to client network 602 by the network hosting the platform 604), and/or servers in data centers 616 to a log management server in data centers 616.

Although FIG. 6 illustrates a specific embodiment of a cloud computing system 600, the disclosure is not limited to the specific embodiments illustrated in FIG. 6. For instance, although FIG. 6 illustrates that the platform 604 is implemented using data centers, other embodiments of the platform 604 are not limited to data centers and can utilize other types of remote network infrastructures. Some embodiments may combine one or more different virtual servers into a single virtual server. The use and discussion of FIG. 6 are only examples to facilitate ease of description and explanation and are not intended to limit the disclosure to the specific examples illustrated therein. In an embodiment, the respective architectures and frameworks discussed with respect to FIG. 6 can incorporate suitable computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

One aspect of the disclosure includes a method for obtaining a graph indicating a plurality of nodes and indicating relationships between the plurality of nodes, wherein each of the plurality of nodes is associated with a corresponding one of a plurality of process elements. The method may further include receiving an edit for a portion of the graph. The method may further include, in response to receiving the edit, identifying a subset of the plurality of nodes that is associated with the portion of the graph. The method may further include, in response to receiving the edit, generating, based on the edit, a command list that targets the subset of the plurality of nodes. The method may further include, in response to receiving the edit, updating the graph by executing the command list.

Implementations of the disclosure may include one or more of the following optional features. The method may include executing the command list to update the subset of the plurality of nodes. The method may additionally include executing the command list to add an edge from one of the plurality of process elements to a new process element. The method may further include executing the command list to add an edge from the new process element to another new process element, and remove the edge from one of the plurality of process elements to the new process element. The method may further include receiving the edit for the portion of the graph is based on a user interface. The method may further include a first process element associated with a first node of the subset of the plurality of nodes and a second process element associated with a second node of the subset of the plurality of nodes. The method may further include the command list, wherein a command list is limited to targeting the subset of the plurality of nodes. The method may further include a command list, wherein the command list is stored at a buffer queue on a first-in first-out (FIFO) basis.

Another aspect of the disclosure includes a system that comprises one or more processors and a memory including computer-executable instructions. The one or more processors, when executing the computer-executable instructions, may cause the system to obtain a graph indicating a plurality of nodes and indicating relationships between the plurality of nodes, wherein each of the plurality of nodes is associated with a corresponding one of a plurality of process elements. The one or more processors may further cause the system to receive an edit for a portion of the graph. The one or more processors may further cause the system, in response to receiving the edit, to identify a subset of the plurality of nodes that is associated with the portion of the graph. The one or more processors may further cause the system, in response to receiving the edit, to generate, based on the edit, a command list that targets the subset of the plurality of nodes. The one or more processors may further cause the system, in response to receiving the edit, to update the graph by executing the command list.

This aspect of the disclosure that includes a system may include one or more of the following optional features. The one or more processors may further cause the system to execute the command list to update a relationship between two or more of the subset of the plurality of nodes. The one or more processors may further cause the system to execute the command list to add an edge from one of the plurality of process elements to a new process element; add an edge from the new process element to another new process element; and remove the edge from one of the plurality of process elements to the new process element. The one or more processors may further cause the system to generate an animation to visualize completion of the edit. The system may further comprise a plurality of nodes, wherein two or more of the plurality of nodes are associated with different process elements. The system may further comprise a subset of a plurality of nodes, wherein the plurality of nodes is limited to nodes required to complete the edit. The system may further comprise a command list, wherein the command list is stored at a buffer queue on a first-in first-out basis to delay updating the graph until execution of one or more other command lists based on one or more other edits have been completed.

Another aspect of the disclosure includes a non-transitory computer-readable storage medium having stored thereon executable instructions, which, when executed by one or more processors of a computer system, cause the computer system to obtain a graph indicating a plurality of nodes and indicating relationships between the plurality of nodes, wherein each of the plurality of nodes is associated with a corresponding one of a plurality of process elements. The computer-readable storage medium may further include instructions that cause the computer system to receive an edit for a portion of the graph. The computer-readable storage medium may further include instructions that cause the computer system, in response to receiving the edit, to identify a subset of the plurality of nodes that is associated with the portion of the graph. The computer-readable storage medium may further include instructions that cause the computer system, in response to receiving the edit, to generate, based on the edit, a command list that targets the subset of the plurality of nodes. The computer-readable storage medium may further include instructions that cause the computer system, in response to receiving the edit, to update the graph by executing the command list.

This aspect of the disclosure that includes a non-transitory computer-readable storage medium may include one or more of the following optional features. The computer-readable storage medium may further include instructions that cause the computer system to execute the command list to update a relationship between two or more of the subset of the plurality of nodes by adding or removing one or more edges. The computer-readable storage medium may further include instructions that cause the computer system to execute the command list to modify one or more edges and one or more nodes. The computer-readable storage medium may further include instructions that cause the computer system to generate a command list that is limited to targeting the subset of the plurality of nodes and one or more edges associated with the subset of the plurality of nodes. The computer-readable storage medium may further include instructions that cause the computer system to store the command list at a buffer queue as a unit on a first-in first-out basis to delay updating the graph until execution of one or more other command lists have been completed.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

Other variations are within the spirit of the resent disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. A method comprising:
receiving, via a network from a client device, an edit for a portion of a graph, wherein the graph is visually represented on the client device and comprises a data structure storing:
data in a plurality of nodes, and
relationships between the plurality of nodes in a plurality of edges connecting the plurality of nodes,
wherein each of the plurality of nodes is associated with a corresponding one of a plurality of process elements; and
in response to receiving the edit:
identifying a subset of the plurality of nodes that is associated with the portion of the graph;
generating, based on the edit, a command list that targets the subset of the plurality of nodes;
executing the command list to generate an edited portion for the portion of the graph; and
sending the edited portion to the client device.

2. (canceled)

3. The method of claim 1, wherein executing the command list includes adding an edge from one of the plurality of process elements to a new process element.

4. The method of claim 3, wherein executing the command list includes adding an edge from the new process element to another new process element, and removing the edge from one of the plurality of process elements to the new process element.

5. The method of claim 1, wherein receiving the edit for the portion of the graph is based on a user interface.

6. The method of claim 1, wherein a first process element is associated with a first node of the subset of the plurality of nodes and a second process element is associated with a second node of the subset of the plurality of nodes.

7. The method of claim 1, wherein the command list is limited to targeting the subset of the plurality of nodes.

8. The method of claim 1, wherein the command list is stored at a buffer queue on a first-in first-out (FIFO) basis.

9. A system, comprising:
one or more processors; and
memory, including computer-executable instructions that, if executed by the one or more processors, cause the system to:
receive, via a network from a client device, an edit for a portion of a graph, wherein the graph is visually represented on the client device and comprises a data structure storing:
data in a plurality of nodes, and
relationships between the plurality of nodes in a plurality of edges connecting the plurality of nodes,
wherein each of the plurality of nodes is associated with a corresponding one of a plurality of process elements; and
in response to receiving the edit:
identify a subset of the plurality of nodes that is associated with the portion of the graph;
generate, based on the edit, a command list that targets the subset of the plurality of nodes;
execute the command list to generate an edited portion for the portion of the graph; and
send the edited portion to the client device.

10. The system of claim 9, wherein executing the command list updates a relationship between two or more of the subset of the plurality of nodes.

11. The system of claim 9, wherein executing the command list includes:
adding an edge from one of the plurality of process elements to a new process element;
adding an edge from the new process element to another new process element; and
removing the edge from one of the plurality of process elements to the new process element.

12. The system of claim 9, wherein the computer-executable instructions that, if executed by the one or more processors, cause the system to generate an animation to visualize completion of the edit.

13. (canceled)

14. The system of claim 9, wherein the subset of the plurality of nodes is limited to nodes required to complete the edit.

15. The system of claim 9, wherein the command list is stored at a buffer queue on a first-in first-out basis to delay updating the graph until execution of one or more other command lists based on one or more other edits have been completed.

16. A non-transitory computer-readable storage medium having stored thereon executable instructions which, when executed by one or more processors of a computer system, cause the computer system to:
receive, via a network from a client device, an edit for a portion of a graph, wherein the graph is visually represented on the client device and comprises a data structure storing:
data in a plurality of nodes, and
relationships between the plurality of nodes in a plurality of edges connecting the plurality of nodes,
wherein each of the plurality of nodes is associated with a corresponding one of a plurality of process elements; and
in response to receiving the edit:
identify a subset of the plurality of nodes that is associated with the portion of the graph;
generate, based on the edit, a command list that targets the subset of the plurality of nodes;
execute the command list to generate an edited portion for the portion of the graph; and
send the edited portion to the client device.

17. The non-transitory computer-readable storage medium of claim 16, wherein executing the command list updates a relationship between two or more of the subset of the plurality of nodes by adding or removing one or more edges.

18. The non-transitory computer-readable storage medium of claim 16, wherein executing the command list includes modifying one or more edges and one or more nodes.

19. The non-transitory computer-readable storage medium of claim 16, wherein the command list is limited to targeting the subset of the plurality of nodes and one or more edges associated with the subset of the plurality of nodes.

20. The non-transitory computer-readable storage medium of claim 16, wherein the command list is stored at a buffer queue as a unit on a first-in first-out basis to delay updating the graph until execution of one or more other command lists have been completed.

21. The system of claim 9, wherein property data of a node of the subset of the plurality of nodes is used by a command of the command list, and the property data is fetched when executing the command.

22. The system of claim 21, wherein the property data of the node comprises metadata of the node, and wherein the metadata comprises a type of the node or a type of activity represented by the node.
